(19) United States
(12) Patent Application Publication
(10) Pub. No.: US 2010/0079491 A1
(43) Pub. Date: Apr. 1, 2010

(54) IMAGE COMPOSITING APPARATUS AND METHOD OF CONTROLLING SAME

(76) Inventor: Shunichiro Nonaka, Tokyo (JP)

Correspondence Address: BIRCH STEWART KOLASCH & BIRCH, PO BOX 747, FALLS CHURCH, VA, 22040-0747, US

(21) Appl. No.: 12/556,020

(22) Filed: Sep. 9, 2009

(30) Foreign Application Priority Data
Sep. 30, 2008 (JP) 2008-252873

(51) Int. Cl. G09G 5/00

(52) U.S. Cl. 345/630

(57) ABSTRACT

A compositing face image for replacing a face image is input and stored. The image of a subject is sensed to obtain the image of the subject. A face image is detected from the image of the subject, and the face orientation and facial expression indicated by the face image are detected. A compositing face image having the face orientation and facial expression detected is substituted for the face image in the image of the subject. The image of the subject in which the face image has been replaced is displayed on a display unit.

### BACKGROUND OF THE INVENTION

1. Field of the Invention

This invention relates to an image compositing apparatus and to a method of controlling this apparatus.

2. Description of the Related Art

In an apparatus that displays moving pictures and game video, there are instances where a displayed face is replaced with another face. For example, there is a system in which an arcade game machine is provided with a video camera so that the user's face can be substituted for the face of a person that appears in a game (see the specification of Registered Japanese Utility Model 3048628). Further, there is a system that automatically tracks the motion of a person's face in a moving picture and makes it possible to compose an image in which the image of the face is transformed into a desired shape (see the specification of Japanese Patent Application Laid-Open No. 2002-269546).

In a case where the face of the user has been imaged, however, a problem arises when the imaged face of the user is displayed. Specifically, although it has been contemplated to replace the imaged face of the user with another face. With such a simple substitution, however, often one cannot tell how the user's face appeared before the substitution.

### SUMMARY OF THE INVENTION

Accordingly, an object of the present invention is to so arrange it that even if the image of a user is replaced with another image, one can tell what the condition of the user was.

According to the present invention, the foregoing object is attained by providing an image compositing apparatus comprising: an image sensing device for sensing the image of a subject and outputting image data representing the image of the subject; a face image detecting device (face image detecting means) for detecting a face image from the image of the subject represented by the image data that has been output from the image sensing device; a face-condition detecting device (face-condition detecting means) for detecting a face condition which is at least one of face orientation and facial expression of emotion indicated by the face image detected by the face image detecting device; a replacing device (replacing means) for replacing the face image, which has been detected by the face image detecting device, with a compositing face image that conforms to the face condition detected by the face-condition detecting device; and a display control device (display control means) for controlling a display unit so as to display the image of the subject in which the face image has been replaced with the compositing face image by the replacing device.

The present invention also provides a control method suited to the above-described image compositing apparatus. Specifically, the invention provides a method of controlling an image compositing apparatus, comprising the steps of: sensing the image of a subject and outputting image data representing the image of the subject; detecting a face image from the image of the subject represented by the image data that has been obtained by image sensing; detecting a face condition which is at least one of face orientation and facial expression of emotion indicated by the face image detected by the face image detection processing; replacing the face image, which has been detected by the face image detection processing, with a compositing face image that conforms to the face condition detected by the face-condition detection processing; and controlling a display unit so as to display the image of the subject in which the face image has been replaced with the compositing face image by the replacement processing.

In accordance with the present invention, the image of a subject is sensed and a face image is detected from the image of the subject obtained by image sensing. The condition of the detected face, which is one or both of the orientation of the face and a facial expression of emotion, is detected. The detected face image is replaced with a compositing face image that conforms to the detected condition of the face. The image of the subject in which the face image has been replaced with the compositing face image is displayed.

Since the face image in the image of the subject obtained by image sensing is replaced with another face image that is a compositing face image, the entire sensed image of the subject can be displayed even in a case where the face of the subject cannot be displayed. In particular, the compositing face image that has been substituted exhibits an orientation and a facial expression of emotion that are the same as those of the detected face image, examples of expression being joy, anger, sadness and amusement, etc. Accordingly, even though the face image in the image of the subject is not displayed, one can ascertain what the face orientation and facial expression of the subject, i.e., the person, were.

The replacing device (a) replaces the face image, which has been detected by the face image detecting device, with a compositing face image that conforms to the condition of the face detected by the face detecting device, this compositing face image being represented by compositing face image data that has been stored, for every face condition, in a compositing face image data storage device; or (b) transforms a prescribed face image into a compositing face image that conforms to the condition of the face detected by the face detecting device and replaces the face image, which has been detected by the face image detecting device, with the compositing face image obtained by the transformation.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram illustrating the electrical configuration of an image compositing apparatus;

FIGS. 2A and 2B illustrate examples of compositing face images;

FIG. 3 is a flowchart illustrating processing executed by an image compositing apparatus;

FIG. 4 illustrates an example of the image of a subject obtained by image sensing;

FIG. 5 illustrates an example of the image of a subject in which the image of the face has been replaced;

FIG. 6 illustrates an example of the image of a subject obtained by image sensing;

FIG. 7 illustrates an example of the image of a subject in which the image of the face has been replaced;

FIGS. 8 and 9 illustrate examples of compositing face images according to another embodiment;

FIG. 10 is a flowchart illustrating processing executed by an image compositing apparatus;

FIG. 11 illustrates examples of decorations according to a further embodiment; and

FIG. 12 illustrates examples of compositing face images according to this embodiment.

### DESCRIPTION OF THE PREFERRED EMBODIMENTS

Preferred embodiments of the present invention will now be described in detail with reference to the accompanying drawings.

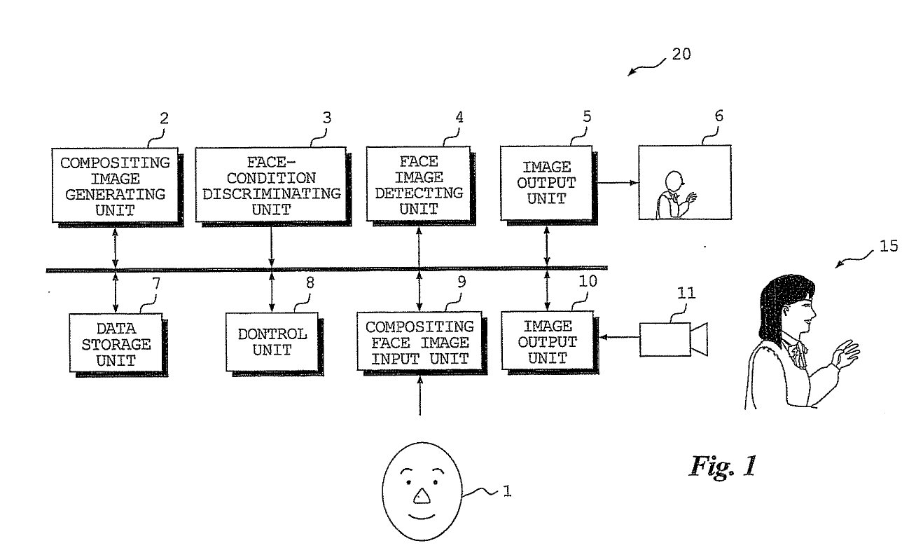

FIG. 1 is a block diagram illustrating the electrical configuration of an image compositing apparatus 20 according to a first embodiment of the present invention.

The image compositing apparatus 20 according to this embodiment senses the image of a subject 15 and displays a face image 1, which is for compositing purposes, that has been substituted for the image of the face contained in the image of the subject obtained by image sensing. To achieve this, the image compositing apparatus 20 includes a compositing face image input unit 9 for inputting compositing face image data representing the compositing face image 1. The compositing face image data that has been input from the compositing face image input unit 9 is applied to and stored temporarily in a data storage unit 7.

The image compositing apparatus 20 further includes a video camera 11 for sensing the image of the subject 15. When the image of the subject 15 is sensed by the video camera 11, image data representing the image of the subject is input to a face image detecting unit 4 via an image input unit 10. The face image detecting unit 4 detects the position of the face image from the image of the subject 15 obtained by sensing the image of the subject 15. When the position of a face image is detected, detection processing can be executed at higher speed and accuracy by utilizing the position and face orientation, etc., of a face image, which has been detected in the frame preceding a specific frame, to execute detection processing while placing emphasis on a face image close to the condition of the face detected in the preceding frame. The data representing the detected position of the face image and the data representing the image of the subject is input to a face-condition discriminating unit 3. The condition of the face (the orientation of the face and a facial expression indicative of a human emotion) represented by the detected face image is discriminated by the face-condition discriminating unit 3. Data representing the condition of the face is input to a compositing image generating unit 2.

The compositing face image data that has been stored in the data storage unit 7 also is input to the compositing image generating unit 2. The compositing image generating unit 2 generates a composite image in which the face image contained in the sensed image of the subject has been replaced with a compositing face image that conforms to the face orientation and facial expression of this face image. For example, if the face image in the image of the subject has a horizontal orientation, the face image in the image of the subject will be replaced with a horizontally oriented compositing face image. Further, if the facial expression represented by the face image in the image of the subject is an expression of anger, then the face image in the image of the subject will be replaced with a compositing face image having an angry expression. A compositing face image thus conforming to face orientation and facial expression can be generated and stored in advance for every face orientation and facial expression, and the compositing face image that conforms to the face orientation and facial expression of the detected face portion can be read out and combined with the image of the subject. Further, a compositing face image having a prescribed face orientation and facial expression can be stored in advance, a compositing face image having a face orientation and facial expression represented by the detected face image can be generated from the stored compositing face image and the generated compositing face image can be combined with the image of the subject.

The image data representing the image of the subject with which the compositing face image has been combined is applied to a display unit 6 from an image output unit 5. As a result, the image of the subject in which the face image has been replaced with the compositing face image is displayed on the display screen of the display unit 6.

For example, on occasions where video is broadcast from a pavement camera, there are instances where a passerby is captured in the video and it is best not to broadcast the face of the passerby as is when the right of likeness of the person is taken into account. At such times the face of the passerby is not broadcast as is. Rather, what can be broadcast instead is video in which the face of the passerby has been replaced with a compositing face image upon taking into consideration the facial expression and face orientation of the passerby. The compositing face image may be an illustration such as a “smiling face” mark or a character representing a celebrity or animated personage. Further, if only face orientation will suffice, then it will suffice to remove the face image and display a border in such a manner that the orientation of the face can be discerned.

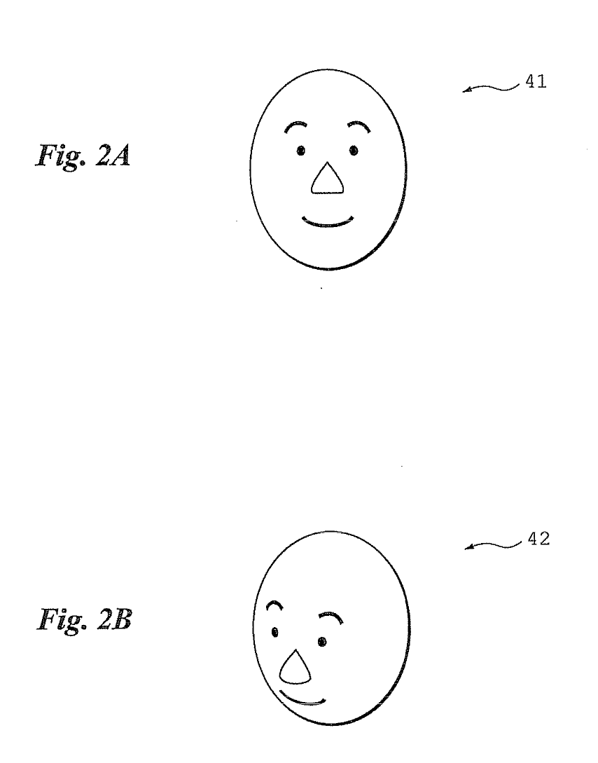

FIGS. 2A and 2B illustrate the manner in which face images having different orientations are generated from a prescribed compositing face image.

FIG. 2A, which is an example of a prescribed compositing face image 41, is a two-dimensional face image. A three-dimensional image is generated from the two-dimensional face image utilizing well-known software. For example, when the three-dimensional face image is generated, the three-dimensional image is expressed solely by lines representing the contour of a solid utilizing one of the three-dimensional representation methods called a “wire-frame model”. The orientation and expression of a three-dimensional face image can be changed by adjusting the constituent elements such as the eyes, mouth, nose and eyebrows that constitute the face in such a manner that they are defined at the control-point positions of the wire-frame model, adjusting the control-point positions and controlling the three-dimensional face image so as to become the adjusted control-point positions.

Further, a right-facing wire-frame transformation method or a smiling-face wire-frame transformation method, etc., can be stored beforehand as a table, and the compositing face image can be transformed in accordance with the transformation method.

In FIG. 2B, the prescribed compositing face image 41 has been changed to a leftward-slanted compositing face image 42 in this manner. It goes without saying that a leftward-slanted orientation does not constitute a limitation and changes can be made to other orientations and expressions as well.

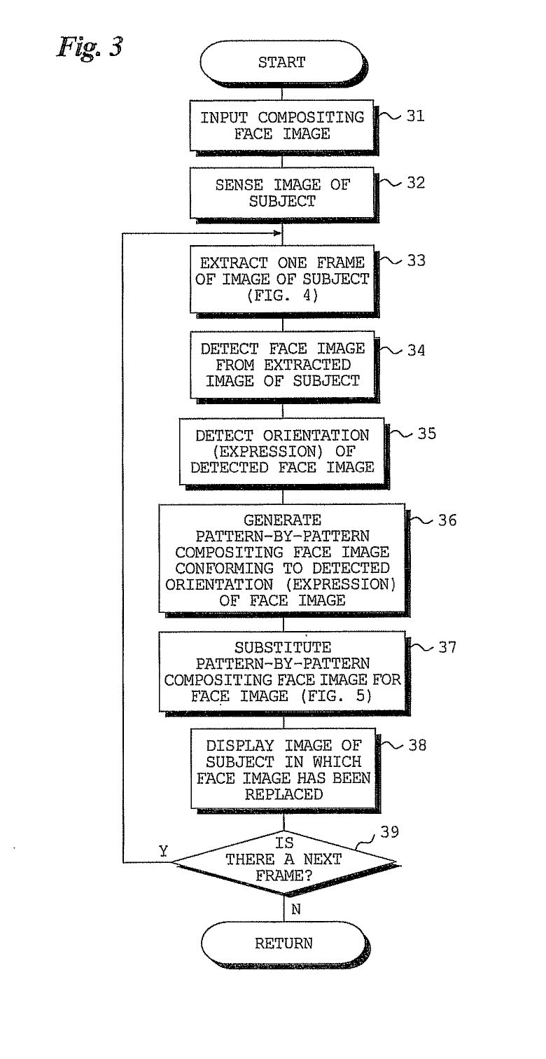

FIG. 3 is a flowchart illustrating processing executed by the image compositing apparatus 20. This processing detects the expression on the face image of a subject and combines the image of the subject with a compositing face image having an expression conforming to the detected facial expression. Further, the compositing face image, rather than being one obtained by generating a plurality of compositing face images beforehand, is one obtained by generating a compositing face image, which has a detected facial expression, from a compositing face image having a prescribed expression.

First, compositing face image data representing a compositing face image having a prescribed expression is input to the image compositing apparatus 20 (step 31). The compositing face image data thus input is stored in the data storage unit 7. The image of a subject is sensed continuously at a fixed period of, e.g., 1/60 of a second (step 32).

A moving image is obtained by such fixed-period imaging and one frame of the image of the subject is extracted from the moving image obtained (step 33). A face image is detected from the extracted frame of the image of the subject (step 34).

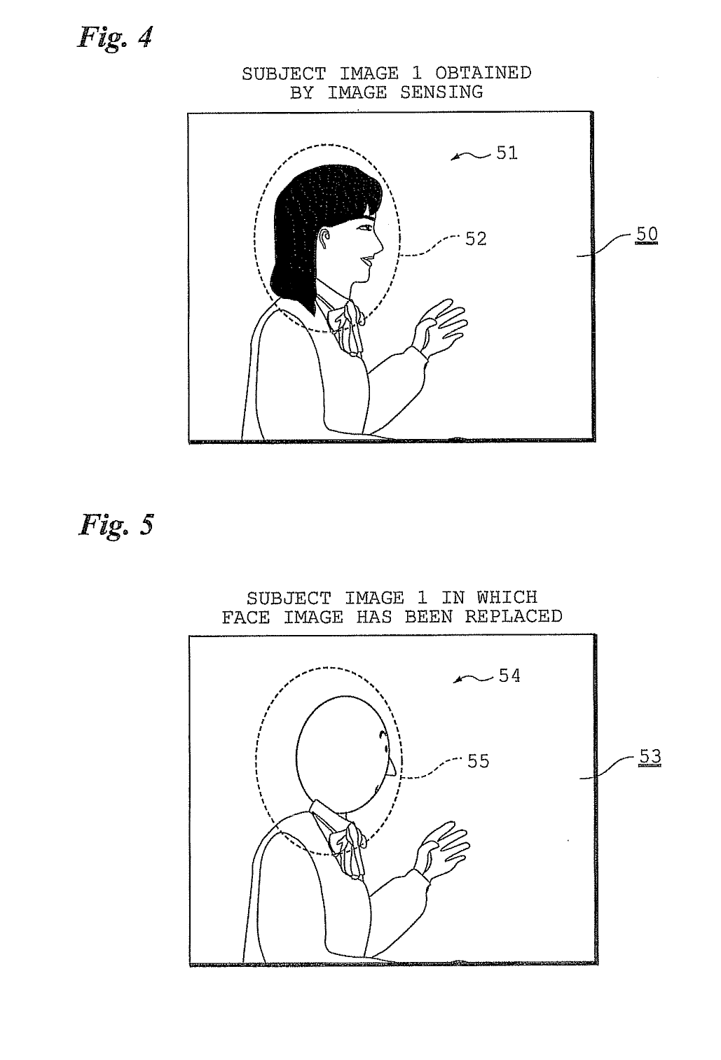

FIG. 4 is an example of one frame of a subject image 50 that has been extracted. The subject image 50 contains an image 51 of a person. A face image 52 of the person image 51 is detected from the subject image 50.

With reference again to FIG. 3, the orientation of the face represented by the detected face image 52 is detected (the expression on the face may be detected instead of the orientation, or it may be so arranged that both the orientation and expression are detected) (step 35). If face orientation is detected, a compositing face image (a pattern-by-pattern compositing face image) that will take on the detected face orientation is generated (step 36). When this is achieved, the pattern-by-pattern compositing face image generated is substituted for the face image of the subject image obtained by image sensing (step 37).

FIG. 5 is an example of a subject image 53 in which the face image 52 has been replaced.

The subject image 53 includes a person image 54. The face image of the person image 54 has been replaced with a pattern-by-pattern compositing face image 55. The pattern-by-pattern compositing face image 55 that has been substituted for the face image 52 is facing rightward, which is the same face orientation represented by the face image 52 in FIG. 4 prior to replacement. Even though the face image is replaced, the condition of the original face image can be ascertained to a certain extent.

With reference again to FIG. 3, the image of the subject in which the face image has been replaced with the pattern-by-pattern compositing face image is displayed on the display screen of the display unit 6 (step 38). If there is a succeeding frame (“YES” at step 39), the processing of steps 33 to 38 is repeated.

In the foregoing embodiment, a face image contained in the image of a subject is replaced with a compositing face image having an orientation identical with that of the face. However, the face image contained in the image of the subject may just as well be replaced with a compositing face image having an expression rather than an orientation identical with that of the face.

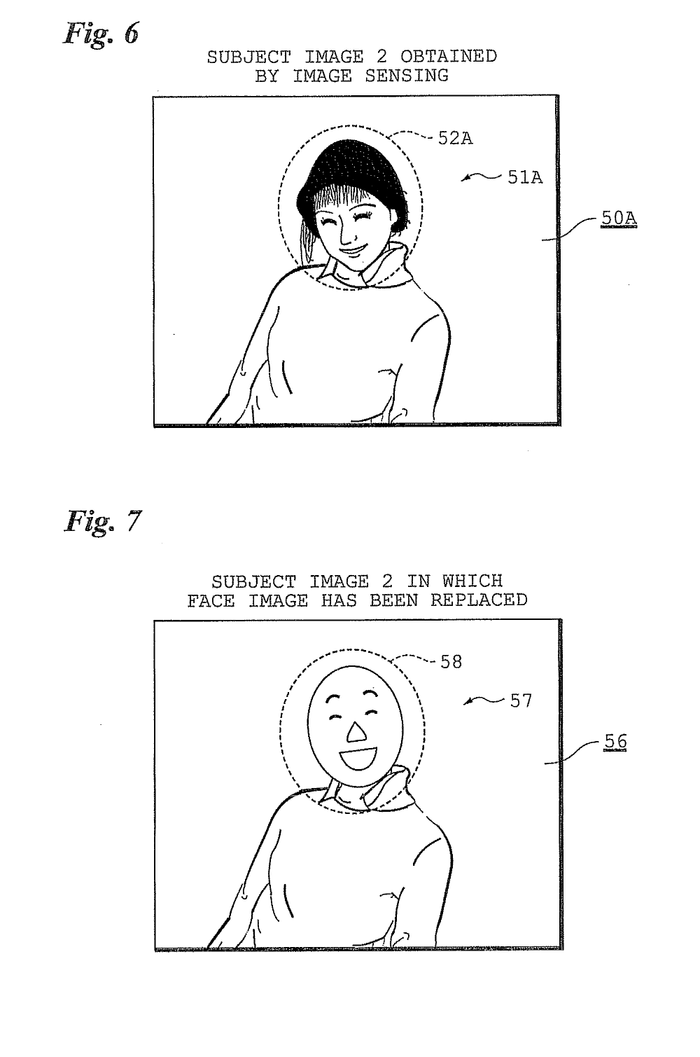

FIG. 6 is an example of a subject image 50A obtained by image sensing.

The subject image 50A includes a person image 51A. A face image 52A is detected from the person image 51A in the manner described above. The expression of the detected face image 52A is detected and a compositing face image having the detected expression is substituted for the face image 52A.

FIG. 7 is an example of a subject image 56 in which the face image 52A has been replaced.

The subject image 56 includes a person image 57, and the face image of the person image 57 has been replaced with a compositing face image 58. On the assumption that the facial expression of the face image 52A of the subject image shown in FIG. 6 has been determined to be a smiling expression, the compositing face image 58 substituted in the subject image 56 shown in FIG. 6 will be a smiling face. Even in such a case where the face image has been replaced, the expression that was on the face image 52A prior to its replacement can be ascertained.

In the foregoing embodiment, face orientation or facial expression is discriminated and a face image is replaced with a compositing face image. However, it may be so arranged that both face orientation and facial expression are discriminated and a compositing face image conforming to both face orientation and facial expression is substituted.

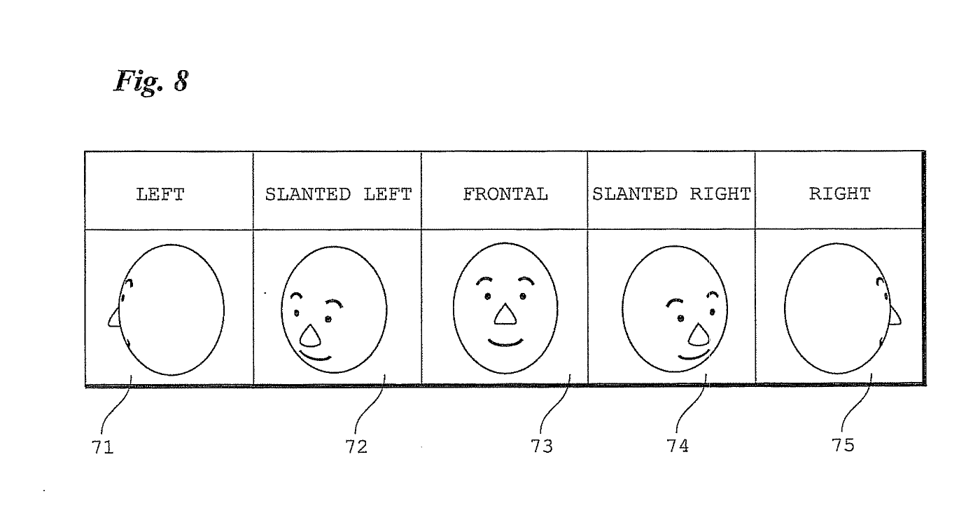

FIGS. 8 to 10 illustrate another embodiment of the invention. This embodiment generates compositing face images in advance.

FIG. 8 illustrates examples of compositing face images having different orientations.

The differently oriented compositing face images include compositing face images 71, 72, 73, 74 and 75 having a leftward-facing orientation, a leftward-slanted orientation, a frontal orientation, a rightward-slanted orientation and a rightward-facing orientation, respectively. These differently oriented compositing face images 71, 72, 73, 74 and 75 have been generated and stored in advance. In the manner described above, a compositing face image having an orientation conforming to the orientation of a face image detected from the image of a subject that has been obtained by image sensing is selected and the selected compositing face image is then substituted for the face image in the image of the subject.

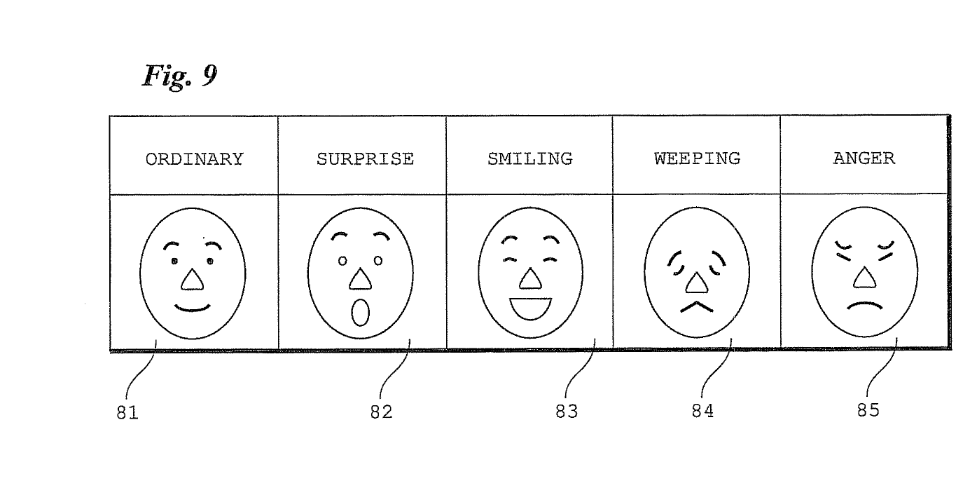

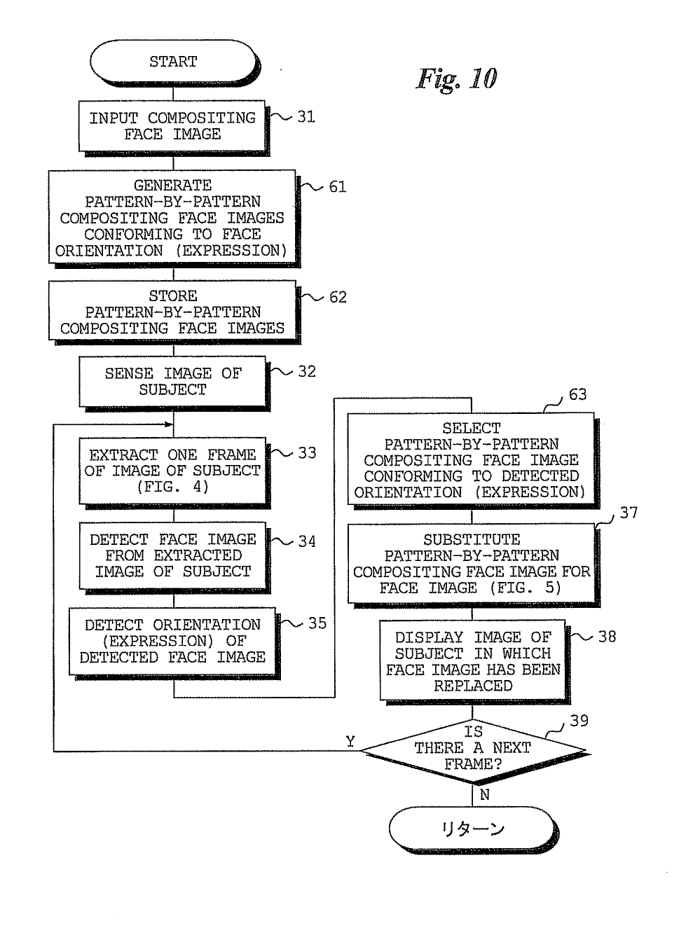

FIG. 9 illustrates examples of compositing face images having different expressions.

The compositing face images having different expressions include compositing face images 81, 82, 83, 84 and 85 exhibiting an ordinary expression, an expression of surprise, a smiling-face expression, a weeping expression and an expression of anger, respectively. These compositing face images 81, 82, 83, 84 and 85 having different expressions have been generated and stored in advance. In the manner described above, a compositing face image having an expression conforming to the expression of a face image detected from the image of a subject that has been obtained by image sensing is selected and the selected compositing face image is then substituted for the face image in the image of the subject.

In the examples described above, the differently oriented compositing face images 71, 72, 73, 74 and 75 and the compositing face images 81, 82, 83, 84 and 85 having different expressions have each been generated and stored. However, it may be so arranged that compositing face images having different expressions are generated and stored for every orientation. In this case, since compositing face images having different expressions would be stored for each one of the orientations, 25 face images would be stored.

FIG. 10 is a flowchart illustrating processing executed by the image compositing apparatus. Processing steps in FIG. 10 identical with those shown in FIG. 3 are designated by like step numbers and need not be described again in detail.

Compositing face image data representing a compositing face image having a prescribed expression and orientation is input to the image compositing apparatus 20 (step 31). When this is done, compositing face images (pattern-by-pattern compositing face images) conforming to face orientations are generated as shown in FIG. 8 (or pattern-by-pattern compositing face images conforming to facial expressions are generated as shown in FIG. 9) (step 61). Image data representing the pattern-by-pattern compositing face images that have been generated is stored in the data storage unit 7 (step 62).

Thereafter, in a manner similar to that of the processing shown in FIG. 3, the face image in the image of the subject obtained by image sensing is detected and the face orientation (facial expression) is detected (steps 32 to 35). An image having the face orientation conforming to the detected face orientation is selected from the pattern-by-pattern compositing face images (step 63), as shown in FIG. 8, and the selected image is substituted for the face image (step 37). In a case where the facial expression of the face image has been detected, an image having the facial expression conforming to the detected facial expression is selected from the pattern-by-pattern compositing face images, as shown in FIG. 9, and the selected image is substituted for the face image. Further, in a case where both the face orientation and facial expression of the face image have been detected, an image having the face orientation and the facial expression conforming to the detected face orientation and facial expression is selected from the plurality of pattern-by-pattern compositing face images and the selected image is substituted for the face image.

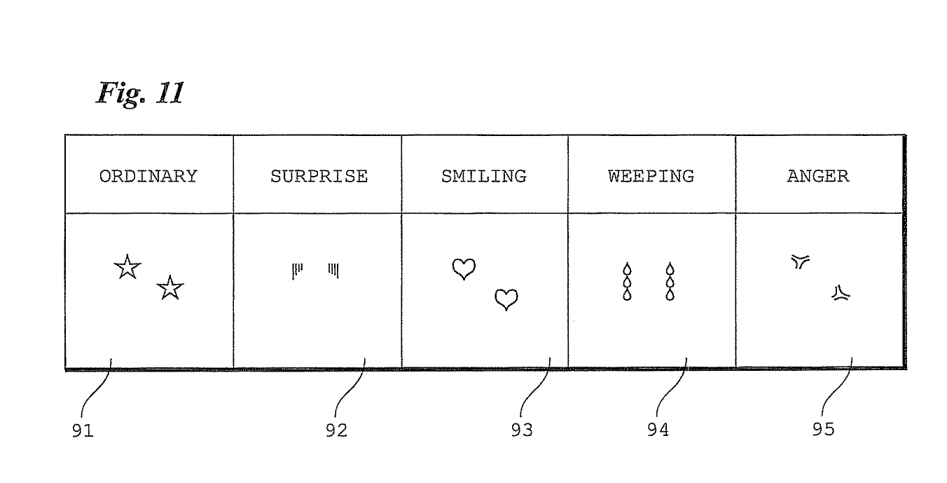

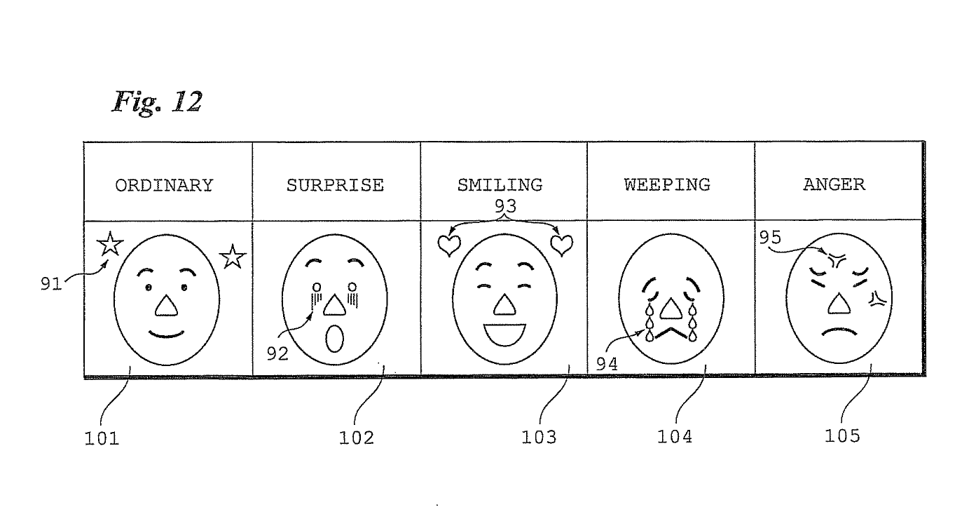

FIGS. 11 and 12 illustrate a further embodiment of the invention.

This embodiment adds a decoration to a compositing face image. FIG. 11 illustrates decorations conforming to facial expressions. Decorations 91, 92, 93, 94 and 95 have been decided in accordance with an ordinary facial expression, a facial expression of surprise, a smiling-face expression, a weeping facial expression and a facial expression of anger, respectively, and these decorations have been stored. A decoration is added to a compositing face image in accordance with the expression of the face image detected from the image of the subject.

FIG. 12 illustrates examples of compositing face images to which decorations have been added. Stored in memory beforehand are a compositing face image 101 having an ordinary facial expression, a compositing face image 102 having a facial expression of surprise, a compositing face image 103 having a smiling-face expression, a compositing face image 104 having a weeping facial expression and a compositing face image 105 having a facial expression of anger, and these compositing face images have been furnished with decorations 91, 92, 93, 94 and 95, respectively, conforming to expressions in accordance with an ordinary facial expression, a facial expression of surprise, a smiling-face expression, a weeping facial expression and a facial expression of anger, respectively. A compositing face image having an expression and a decoration conforming to the expression on the face in the image of the subject can be substituted for the face image in the image of the subject.

Furthermore, an arrangement may be adopted in which a compositing face image in which the orientation of the decoration has been changed in accordance with the orientation of the face in the image of the subject is substituted for the face image in the image of the subject.

As many apparently widely different embodiments of the present invention can be made without departing from the spirit and scope thereof, it is to be understood that the invention is not limited to the specific embodiments thereof except as defined in the appended claims.

What is claimed is:

1. An image compositing apparatus comprising:
an image sensing device for sensing the image of a subject and outputting image data representing the image of the subject;
a face image detecting device for detecting a face image from the image of the subject represented by the image data that has been output from said image sensing device;
a face-condition detecting device for detecting a face condition which is at least one of face orientation and facial expression of emotion indicated by the face image detected by the face image detecting device;
a replacing device for replacing the face image, which has been detected by said face image detecting device, with a compositing face image that conforms to the face condition detected by said face-condition detecting device; and
a display control device for controlling a display unit so as to display the image of the subject in which the face image has been replaced with the compositing face image by said replacing device.

2. The apparatus according to claim 1, wherein said replacing device replaces the face image, which has been detected by said face image detecting device, with a compositing face image that conforms to the condition of the face detected by said face detecting device, this compositing face image being represented by compositing face image data that has been stored, for every face condition, in a compositing face image data storage device; or transforms a prescribed face image into a compositing face image that conforms to the condition of the face detected by said face detecting device and replaces the face image, which has been detected by said face image detecting device, with the compositing face image obtained by the transformation.

3. A method of controlling an image compositing apparatus, comprising the steps of:
sensing the image of a subject and outputting image data representing the image of the subject;
detecting a face image from the image of the subject represented by the image data that has been obtained by image sensing;
detecting a face condition which is at least one of face orientation and facial expression of emotion indicated by the face image detected by the face image detection processing;
replacing the face image, which has been detected by the face image detection processing, with a compositing face image that conforms to the face condition detected by the face-condition detection processing; and
controlling a display unit so as to display the image of the subject in which the face image has been replaced with the compositing face image by the replacement processing.
